(19) United States
(12) Patent Application Publication
(10) Pub. No.: US 2025/0146092 A1
(43) Pub. Date: May 8, 2025

(54) METHOD FOR MANUFACTURING STEEL PLATE COMPONENT AND MANUFACTURING APPARATUS

(71) Applicant: TOYOTA JIDOSHA KABUSHIKI KAISHA, Toyota-shi (JP)

(72) Inventors: Tomoaki IHARA, Toyota-shi (JP); Motoyuki SHIBATA, Nisshin-shi (JP); Ryo SUZUKI, Nagoya-shi (JP)

(73) Assignee: TOYOTA JIDOSHA KABUSHIKI KAISHA, Toyota-shi (JP)

(21) Appl. No.: 18/922,999

(22) Filed: Oct. 22, 2024

(30) Foreign Application Priority Data
Oct. 23, 2023 (JP) 2023-181549
Oct. 10, 2024 (JP) 2024-177823

(51) Int. Cl. C21D 1/42; C21D 8/02

(52) U.S. Cl. CPC C21D 1/42; C21D 8/0205; C21D 8/0221; C21D 8/0294; C21D 2221/00

(57) ABSTRACT

A method or the like for manufacturing a steel plate component, capable of maintaining the overall strength of the component and preventing a delayed fracture from occurring at the same time is provided. A method for manufacturing a steel plate component is characterized in that the steel plate component is locally heated by a heating electrode, the heating electrode being disposed on one side of the steel plate component, and spaced from and directly opposed to a punched part of the steel plate. The steel plate component is a high-strength steel plate having a tensile strength class of 780 MPa or higher. A heating temperature is 500 to 830° C. The steel plate component is locally heated by high-frequency induction for a short time period of 10 seconds or shorter. The heating electrode is a coil larger than the punched part and has two turns or more for the punched part.

### CROSS REFERENCE TO RELATED APPLICATIONS

This application is based upon and claims the benefit of priority from Japanese patent application No. 2023-181549, filed on Oct. 23, 2023, and Japanese patent application No. 2024-177823, filed on Oct. 10, 2024, the disclosure of which is incorporated herein in its entirety by reference.

### BACKGROUND

The present disclosure relates to a method for manufacturing a steel plate component and a manufacturing apparatus.

Reducing the weight of a vehicle is an important challenge to increase the cruising range in the cased of a BEV (Battery Electric Vehicle) and to improve fuel efficiency in the case of a conventional vehicle, and thereby to reduce the CO2 emission. Therefore, it has been studied to integrate a plurality of parts into one component and reduce the wall thickness of such a component by using a high-strength steel plate.

### SUMMARY

One of problems that occurs when a high-strength steel plate is used is a delayed fracture. The delayed fracture is a phenomenon in which a metal material that has been subjected to a constant tensile load suddenly fails after a certain time has elapsed.

It has been known that such a delayed fracture occurs due to a combination of a corrosive environment and a material, and the synergistic effect of a tensile stress. In metal plate components, since a high residual stress remains in a punched end face, a delayed fracture is likely to occur in the punched end face, thus causing a major barrier to the increase of the use of high-strength steel plates. Therefore, in conventional metal plate components, there has been no choice but to use one of the following methods for parts in which the risk of a delayed fracture is high, i.e., avoiding the use of a high-strength steel plate, avoiding a corrosive environment, and adopting a structure in which no residual stress occurs.

In the method disclosed in Japanese Patent No. 7207283, a technique for improving flange ductility by sandwiching an edge end face of a steel plate with electrodes, feeding an electric current therethrough, and thereby heating an area near the edge of the steel plate is disclosed.

However, in order to stabilize the heating range, periodic maintenance of the electrodes is required, so that the cost for the electrodes increases, and a large number of processes for the maintenance and the quality control are required. Further, since the technique uses a structure in which an unheated part is sandwiched between two upper and lower electrodes, the unheated surface may be in the vertical direction. Further, when the unheated surface or the like has a complicated shape, it cannot be heated in some cases. Further, according to Japanese Patent No. 7207283, induction heating is also possible. However, in that case, heating coils are arranged above and below the work plane (electrodes opposed to each other are arranged). This method is inefficient because the heating range is wide, and it is not possible to perform local heating in which only the area near the edge is accurately heated.

The present disclosure has been made in order to solve the above-described problems, and an object thereof is to provide a method or the like for manufacturing a steel plate component, capable of maintaining the overall strength of the component and preventing a delayed fracture from occurring at the same time.

A method for manufacturing a steel plate component according to an aspect of the present disclosure is characterized in that the steel plate component is locally heated by a heating electrode, the heating electrode being disposed on one side of the steel plate component, and spaced from and directly opposed to a punched part of the steel plate.

A manufacturing apparatus for a steel plate component according to an aspect of the present disclosure includes:
a high-frequency AC (Alternating Current) power supply;
a coil connected to the high-frequency AC power supply; and
a mounting base on which the steel plate is mounted, in which
the mounting base is configured so that when the steel plate is mounted thereon, a processed part for the steel plate is directly opposed to the coil, and
the manufacturing apparatus is configured to perform the above-described the manufacturing method.

According to the present disclosure, it is possible to provide a method, an apparatus (system), and the like for manufacturing a steel plate component, capable of maintaining the overall strength of the component and preventing a delayed fracture from occurring at the same time.

The above and other objects, features and advantages of the present disclosure will become more fully understood from the detailed description given hereinbelow and the accompanying drawings.

### BRIEF DESCRIPTION OF DRAWINGS

FIG. 1 is a schematic perspective view for explaining a method for manufacturing a steel plate component according to the present disclosure;

FIG. 2 is a diagram for explaining each step in the method for manufacturing a steel plate component according to the embodiment;

FIG. 3 shows a diagram and a picture for explaining an evaluation method of a hydrochloric acid immersion test according to an embodiment;

FIG. 4 shows a diagram and pictures for explaining results of evaluations in a hydrochloric acid immersion test for a cut-out part for which local heating was not performed according to a comparative example;

FIG. 5 shows pictures for explaining results of evaluations in a hydrochloric acid immersion test for a cut-out part for which local heating was performed according to an embodiment;

FIG. 6 shows a drawing and a graph for explaining a distribution of temperatures in a circumferential direction of a punched end after the local heating shown in FIG. 2;

FIG. 7 shows drawings and a graph for explaining a distribution of temperatures in an end face vertical direction of the punched end after the local heating shown in FIG. 2;

FIG. 8 is a diagram for explaining an example of a part to be subjected to local heating according to an embodiment;

FIG. 9 is a diagram for explaining another example of a part to be subjected to local heating according to an embodiment; and

FIG. 10 is a diagram for explaining an example of an apparatus (system) for local heating using a laser beam according to another embodiment; and

FIG. 11 is a plan view for explaining a punched end and the shape of a coil.

### DESCRIPTION OF EMBODIMENTS

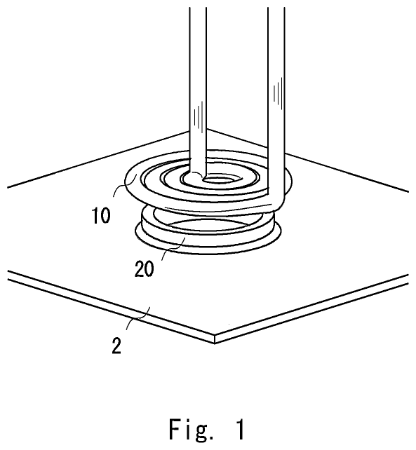

An outline of a method for manufacturing a steel plate component according to the present disclosure will be described with reference to FIG. 1.

A method in which a residual stress is reduced by locally heating punched ends 20 of a high-strength steel plate, which have originally high residual stresses, and a delayed fracture is thereby prevented from occurring is provided.

Therefore, the method for manufacturing a steel plate component according to the present disclosure is characterized in that a processed part (e.g., a punched end 20) of a steel plate is locally heated by a heating electrode (e.g., a coil) which is spaced from and directly opposed to the processed part. In this specification, the expression “to be directly opposed to” means, for example, that a processed part (e.g., a punched end 20) of a steel plate and a heating electrode (e.g., a coil) can be arranged substantially or roughly in parallel with each other with a distance of 10 mm or shorter therebetween and without being in contact with each other. As shown in FIG. 1, the processed part (e.g., the punched end 20) of the steel plate projects toward the heating electrode (e.g., the coil) and extends in a cylindrical shape. In other words, the projecting tip (punched end face) and the heating electrode (e.g., the coil) can be arranged in a non-contact state and roughly parallel to each other within 10 mm.

More specifically, a punched end 20 of a high-strength steel plate having a tensile strength class of 780 MPa or higher may be heated at 500 to 830° C. for a short time period of 10 seconds or shorter. In this way, it is possible to reduce the residual stress and prevent a delayed fracture from occurring. In this process, it is preferable to use high-frequency induction heating to locally heat the punched end 20 for a short time period. The number of turns of the coil can be arbitrarily set, but a coil having at least two turns is preferably overlapped with (e.g., placed above or below) the punched end 20 as shown in FIG. 1. Further, by disposing the coil 10 so as to be directly opposed to the punched end 20, the punched end 20 can be heated in a concentrated manner, and the deformation of a panel 2 can be minimized.

Although it is possible to reduce the residual stress and prevent a delayed fracture from occurring even when the length of the heating is 10 seconds or longer, the heat-affected part (of the panel 2) spreads over a wide area due to the heat transfer, and the strength of the component may be reduced. Therefore, it is preferable to finish the heating in as short a time period as possible.

### First Embodiment

Embodiments according to the present disclosure will be described hereinafter with reference to the drawings.

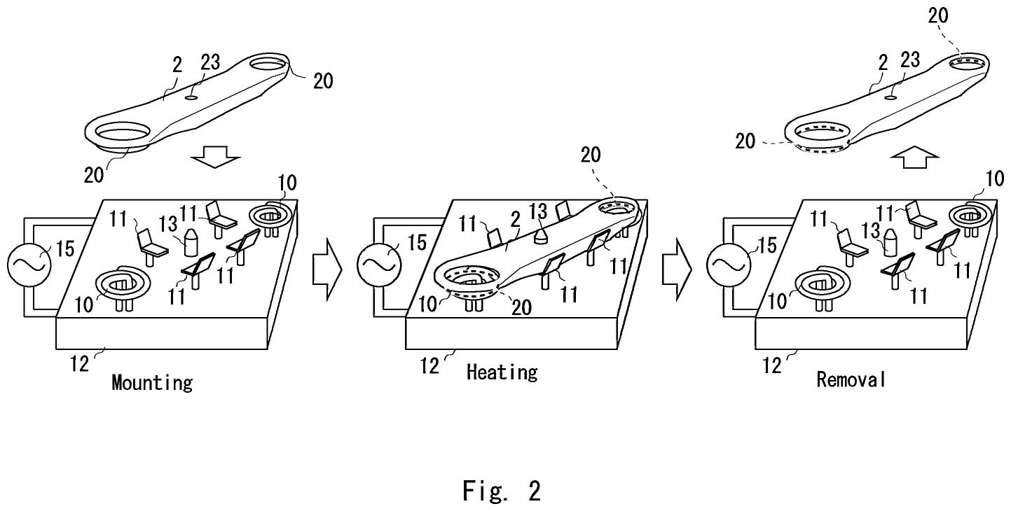

FIG. 2 is a diagram for explaining each step (mounting, heating, and removal) in a method for manufacturing a steel plate component.

Four L-shaped mounting bases 11 on which a long and narrow steel plate component 2 is mounted are provided at or near the center of the upper surface of a rectangular base part 12. Further, on the upper surface of the rectangular base part 12, two coils 10 are provided at both ends on a diagonal line of the base part 12. An AC (Alternating Current) power source 15 that generates a high-frequency 30 induction electromotive force by feeding an AC current through the coil 10 (i.e., each coil 10) is connected to the coil 10.

Punching ends 20 are provided on both ends of the long and narrow steel plate component 2. Each of the punching ends 20 is obtained by forming a hole in a raw material and performing a process for stretching (or shaping) the edge of the hole into a cylindrical shape. This process is also called burring.

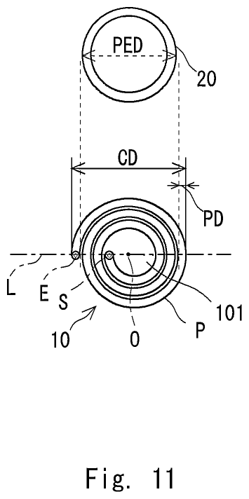

When the long and narrow steel plate component 2 is mounted on the four L-shaped mounting bases 11, the two punched ends 20 at both ends of the steel plate component 2 are positioned so as to be directly opposed to the coils 10, respectively, roughly in parallel therewith. A positioning mechanism (e.g., a pin hole(s) 23 in the steel plate component 2 shown in FIG. 2 and a pin(s) 13 in the base part 12) may be provided so that the steel plate component 2 is directly opposed to the coils 10 roughly in parallel therewith. The axes of the two coils 10 may be perpendicular to the upper surface of the base part 12. They are aligned so that the outermost parts of the coils 10 are partially overlapped with (e.g., placed above or below) the punched ends 20, respectively. In this way, the heating of the panel 2 is suppressed, and the punched ends 20 are locally heated. The diameter of the coil (i.e., each coil) is slightly larger than the diameter of the punched end 20 (i.e., each punched end 20). The coil can be a coiled copper tube (or copper pipe coil). As shown in FIG. 11, the coil diameter CD may be, at most, equal to or shorter than the sum of the diameter PED of the punched end and a length corresponding the pipe diameters PD of the two pipes P forming the coil. In this way, it is possible to prevent the punched end from being widely heated to an area beyond the punched end, and thereby to heat locally the punched end more appropriately. Further, the input end S and the output end E of the coil are arranged on one semidiameter of the coil (one side) extending from the center O of the coil along the diameter L of the coil. In this way, it is possible to achieve more uniform heating by arranging the number of turns of the coil roughly uniformly over the whole punched end. As a result, the delayed fracture can be prevented. The coil 10 may be, for example, a coil having two turns or more for the punched end 20 in order to ensure a sufficient magnetic field for rapid heating. The only one turn of the coil is not connected to each other at its folded part (i.e., the input terminal S and the output terminal E are not connected to each other). The magnetic field spreads only in this discontinuous part, so that the current density does not increase. As a result, the rise in temperature at this part becomes low, so that variations in temperature occur as a whole. Therefore, uniform heating can be achieved by using the coil having two turns or more. As a result, the delayed fracture in the discontinuous part can be prevented. As shown in FIGS. 1 and 2, a coil having at least two turns is overlapped with the punched end 20 (i.e., each punched end 20). After that, the AC power supply 15 is turned on and an AC current is fed through each of the coils 10. As a result, high-frequency induction electromotive forces are generated and the punched ends 20 at both ends of the steel plate component 2 are locally heated.

After heating the punched ends 20 for a short time period (e.g., 10 seconds or shorter) by using the manufacturing apparatus for a steel plate component (local heating apparatus) described above, the AC power supply 15 is turned off and the steel plate component 2 is removed. The punched ends 20 of the steel plate component 2 are uniformly heated (details of which will be described later).

According to the first embodiment, since the distortion of the high-strength steel plate, which would otherwise be caused by the heating process or the like, is removed by the use of the high-frequency induction heating, a delayed fracture can be prevented from occurring. Local heating at 500 to 830° C. is performed for a short time period of 10 seconds or shorter. By locally heating the punched ends by the coils directly opposed to the punched end surfaces, it is possible to prevent the softening of the entire component and maintain the strength of the component. Thermal deformation of the panel can be suppressed by the arrangement of the coils in which the coils are directly opposed to the punched end surfaces. The punched end surfaces can be heated as described above with reference to FIG. 2 in an arbitrary step after the press punching step or before a painting step. Note that in other embodiments, this local heating step may be performed (i.e., included) in the press punching step.

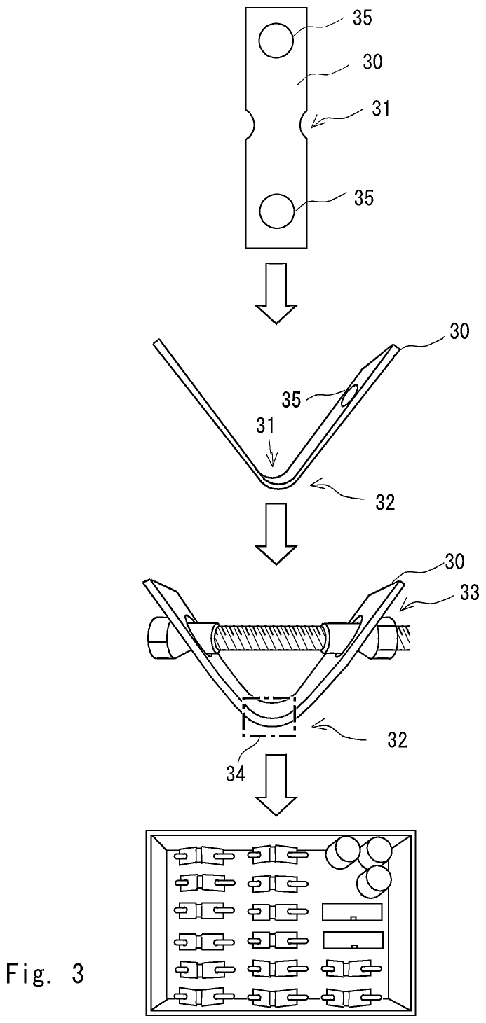

A hydrochloric acid immersion test performed on a manufactured steel plate component will be described with reference to FIGS. 3 to 5.

A high-strength steel plate cut into a rectangular shape in which bolt holes 35 are formed at both ends by a drill was prepared. A cut-out of R5 was formed at the center of the high-strength steel plate by a punching process, and the edge thereof was bent at a bending angle of 90 degrees so that the tip became R6. After that, a stress was applied to the apex of the bending (hereinafter also referred to as the bending apex) by tightening a bolt, and a hydrochloric acid immersion test (PH3, 100H) was carried out.

FIG. 3 shows a procedure for evaluating a delayed fracture in the bending. 1) A blank 30 having a rectangular shape (C 110 mm×L 30 mm) was prepared. A cut-out 31 of R5 was formed at the center in the longitudinal direction of the blank by punching. 2) A V-bend 32 (Tip R6, Bending angle 90°) was formed near the cut-out 31 of the blank 30. 3) A stress that occurred at the bending apex 34 was adjusted by tightening a bolt 33 inserted into the bolt hole 35. 4) A hydrochloric acid immersion test (PH3, 100H) was performed to evaluate a delayed fracture of the bending.

When an end surface was heated according to this embodiment, a part which became the cut-out 31 when the blank was manufactured was locally heated.

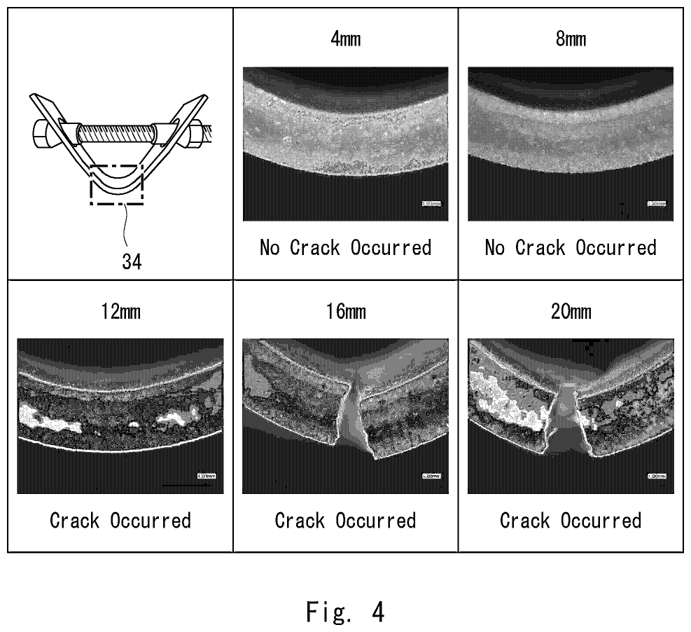

FIG. 4 shows a diagram and pictures for explaining results of evaluations in a hydrochloric acid immersion test for a cut-out part for which local heating was not performed according to a comparative example.

Each of the pictures shown in FIG. 4 is an enlarged photograph of the bending apex when the tightening amount of the bolt was 4 mm, 8 mm, 12 mm, 16 mm, and 20 mm, respectively. As shown in FIG. 4, when the tightening amount of the bolt was 4 mm, 8 mm, or 12 mm, no crack was formed at the bending apex. In contrast, when the tightening amount of the bolt was 16 mm or 20 mm, a crack was formed at the bending apex.

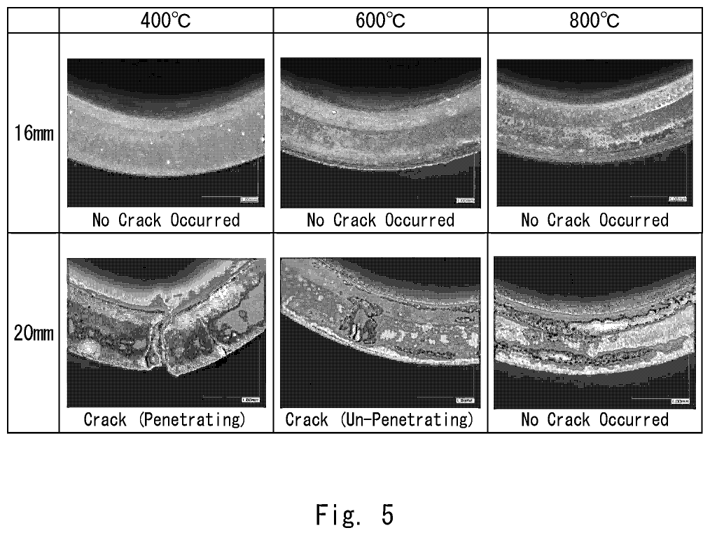

FIG. 5 shows pictures for explaining results of evaluations in a hydrochloric acid immersion test for a cut-out part for which local heating was performed according to the first embodiment.

The cut-out part 31 was locally heated to each of 400° C., 600° C., and 800° C. according to this embodiment, and then naturally cooled.

When the tightening amount was 16 mm or 20 mm, a hydrochloric acid immersion test was carried out (under the conditions under which a crack occurred when heating was not performed as shown in FIG. 4).

As shown in FIG. 5, when the tightening amount of the bolt was 16 mm, no crack occurred at the bending apex at any of 400° C., 600° C., and 800° C. In contrast, when the tightening amount of the bolt was 20 mm, a crack penetrating (i.e., extending throughout) the bending apex occurred at 400° C. When the tightening amount of the bolt was 20 mm, a crack that did not penetrate the bending apex occurred even at 600° C. When the tightening amount of the bolt was 20 mm, no crack occurred at the bending apex at 800° C. That is, when the tightening amount of the bolt was 20 mm, it was possible to reduce (i.e., alleviate) the crack by increasing the heating temperature of the local heating according to this embodiment, and at 800° C., to prevent a crack from being formed. As described above, it was possible to prevent or suppress a delayed fracture by adopting the local heating according to this embodiment. Note that the required temperature may vary depending on the material and the residual stress conditions.

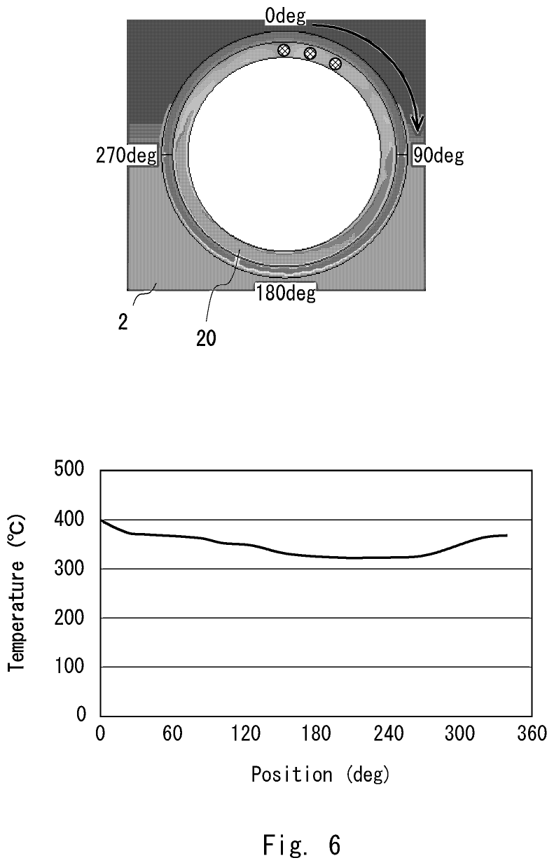

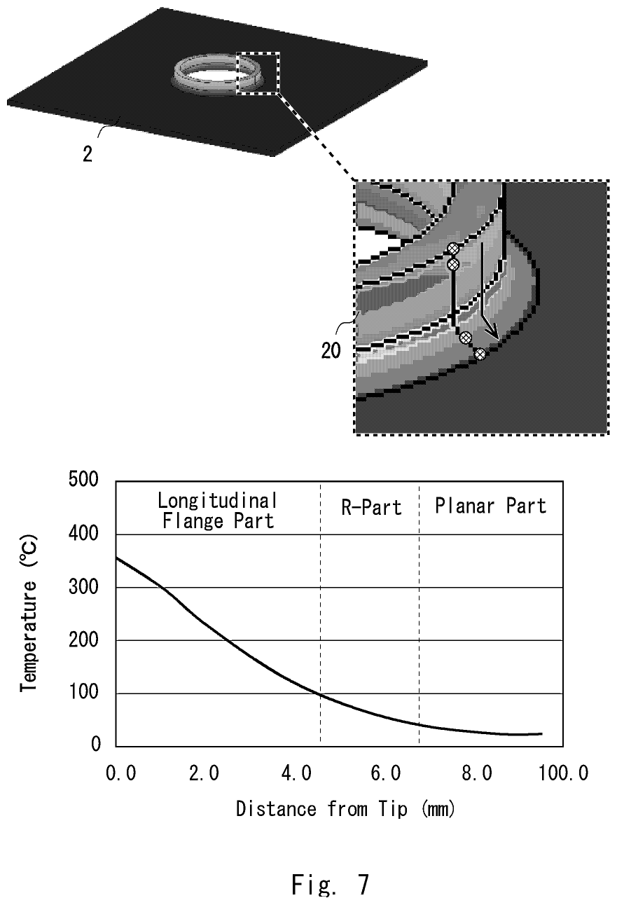

A CAE (Computer Aided Engineering) analysis of the heating temperature will be described with reference to FIGS. 6 and 7.

Rises in temperature at punched ends were analyzed after an AC current having a frequency of 240 kHz was fed at a constant voltage of 200 V for one second.

FIG. 6 shows a drawing and a graph for explaining a distribution of temperatures in a circumferential direction of a punched end 20 after the local heating shown in FIG. 2. The drawing shown in the upper part of FIG. 6 shows the CAE analysis of the heating temperature when the punched end is observed from above. After heating the punched end for one second, the temperature rose to a maximum temperature of 450° C. at and around the end surface. As shown in the graph shown in the lower part of FIG. 6, the temperature at the central part of the end surface has a distribution of temperatures equal to or lower than 70° C. at the maximum even within one circumference of the end surface part, indicating that the temperature difference is small and stable. As described above, it is possible to roughly uniformly heat the punched end 20 by locally heating it by high-frequency induction heating by the coil 10 in the arrangement in which the punched end 20 is disposed so as to be directly opposed to the coil 10 roughly in parallel therewith.

FIG. 7 shows drawings and a graph for explaining a distribution of temperatures in an end face vertical direction of the punched end 20 after the local heating shown in FIG. 2. The drawings shown in the upper part of FIG. 7 show the CAE analysis of the heating temperature as the punched end is observed obliquely from above.

The temperature was repeatedly measured by lowering the measuring point along the outer periphery of the end face by 0.5 mm at a time from the corner of the upper surface. As shown in the graph shown in the lower part of FIG. 7, the temperature returned to that of the remaining part at about 6 mm from the corner of the upper surface, so that it is considered that the influence of the heat is limited to the inside of the vertical flange part and the influence on the strength of the component is small. Therefore, by heating the burring part, i.e., the punched end 20, by the local heating according to this embodiment, it is possible to maintain the overall strength of the component and prevent a delayed fracture from occurring at the same time.

### Heating Target Part

The part where the method according to the present disclosure is used is a component made of a high-strength steel plate having a tensile strength class of 780 MPa or higher and has been subjected to a large strain caused by punching or bending. Further, the method is mainly applied to components to which a tensile stress is applied when they are used and which are expected to be used in a part where there is a large amount of environmental hydrogen such as in a corrosive environment. Examples of specific target components include the below-shown components.

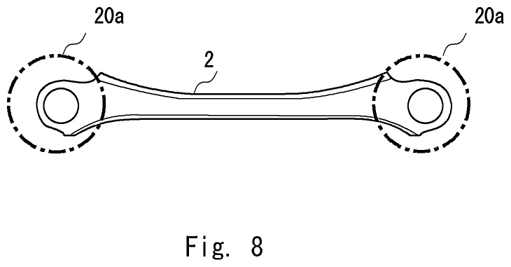

FIG. 8 shows a bush-press-fitting part of an arm or the like, which is an example of the heating target part.

In arms such as rear control arms, there is a press-fitting part 20a which is used by press-fitting a bush (an example of a processed part made of a steel plate). Since such parts are formed by hole spreading forming after a punching process, a very high residual stress remains. Further, since a tensile residual stress is applied by press-fitting of the component, a delayed fracture is likely to be induced (i.e., likely to occur). Therefore, the local heating method according to the present disclosure can also be applied to a bush-press-fitting part processed as described above.

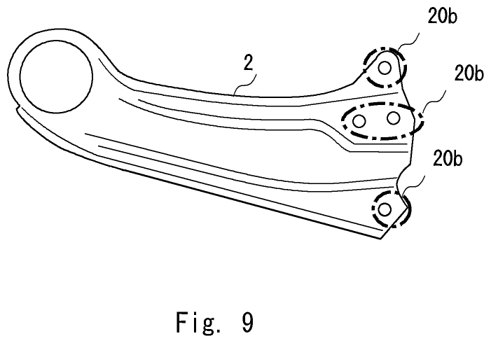

FIG. 9 shows a bolt-tightened part of a trading arm or the like, which is an example of the heating target part.

Trading arms are often fastened with bolts. In addition to the residual stress caused by the punching process for the tightening hole, a tensile residual stress may occur during the tightening due to the poor surface accuracy of the tightening surface in a bolt-tightened part 20b (an example of a processed part made of a steel plate), so that a delayed fracture is likely to be induced (i.e., likely to occur). Therefore, the local heating method according to the present disclosure can also be applied to a bolt-tightened part processed as described above.

Note that in general, a residual stress may increase near a boundary between a shear surface and a fracture surface in a punched end surface. Which part of the punched end surface this boundary part is formed in depends on the material and the plate thickness. The local heating according to this embodiment is preferably performed near this boundary.

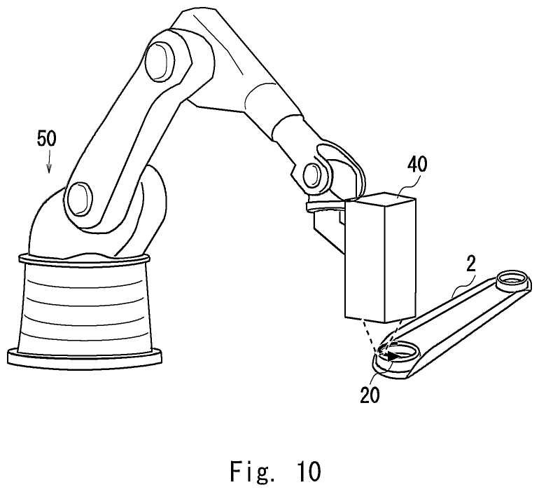

FIG. 10 is a diagram for explaining an example of an apparatus for local heating by a laser beam according to another embodiment.

In the case of laser heating, it is also possible to obtain effects similar to those of the above-described embodiment. For example, a laser source 40 is attached to the tip of an arm of a six-axis robot 50. As described above, the laser source 40 may emit a laser beam while moving the laser beam in the circumferential direction along the punched end.

Note that the present disclosure is not limited to the above-described embodiments, and they may be modified as appropriate without departing from the scope and spirit of the disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method for manufacturing a steel plate component, wherein the steel plate component is locally heated by a heating electrode, the heating electrode being disposed on one side of the steel plate component, and spaced from and directly opposed to a punched part of the steel plate.

2. The method for manufacturing a steel plate component according to claim 1, wherein the steel plate is a high-strength steel plate having a tensile strength class of 780 MPa or higher.

3. The method for manufacturing a steel plate component according to claim 1, wherein the steel plate is locally heated by high-frequency induction for a short time period of 10 seconds or shorter.

4. The method for manufacturing a steel plate component according to claim 1, wherein a heating temperature is 500 to 830° C.

5. The method for manufacturing a steel plate component according to claim 1, wherein
the processed part of the steel plate is formed so as to project on one side of the steel plate by a punching process, and
the heating electrode is disposed so as to be directly opposed to a punched end surface, the punched end surface being a tip which is formed as the processed part projects.

6. The method for manufacturing a steel plate component according to claim 1, wherein
the processed part of the steel plate is a bush-press-fitting part formed by hole spreading forming after a punching process, and
the heating electrode is disposed so as to be directly opposed to the bush-press-fitting part.

7. The method for manufacturing a steel plate component according to claim 1, wherein
the processed part of the steel plate is a bolt-tightened part formed by a punching process, and
the heating electrode is disposed so as to be directly opposed to the bolt-tightened part.

8. The method for manufacturing a steel plate component according to claim 1, wherein the heating electrode is a coil larger than the punched part and has two turns or more for the punched part.

9. The method for manufacturing a steel plate component according to claim 8, wherein an outermost part of the coil is disposed so as to be aligned with the punched end surface formed by a punching process.

10. The method for manufacturing a steel plate component according to claim 8, wherein the coil is a pipe coil, and a diameter of the pipe coil is equal to or shorter than a sum of a diameter of the punched end and a length corresponding to two time the pipe diameter PD of the pipe coil.

11. The method for manufacturing a steel plate component according to claim 8, wherein an input end and an output end of the coil are arranged on the semidiameter of the coil from the center of the coil.

12. A manufacturing apparatus for a steel plate component, comprising:
a high-frequency AC (Alternating Current) power supply;
a coil connected to the high-frequency AC power supply; and
a mounting base on which the steel plate component is mounted, wherein
the mounting base is configured so that when the steel plate component is mounted thereon, a processed part of the steel plate is directly opposed to the coil, and
the manufacturing apparatus is configured to perform the method according to claim 1.
